(19) United States
(12) Patent Application Publication
(10) Pub. No.: US 2008/0005284 A1
(43) Pub. Date: Jan. 3, 2008

(54) Method and Apparatus For Publishing Textual Information To A Web Page

(75) Inventors: Lyle H. Ungar, Philadelphia, PA (US); Dean P. Foster, Philadelphia, PA (US)

Correspondence Address: SYNNESTVEDT & LECHNER, LLP, 1101 MARKET STREET, 26TH FLOOR, PHILADELPHIA, PA, 19107-2950, US

(73) Assignee: THE TRUSTEES OF THE UNIVERSITY OF PENNSYLVANIA, Philadelphia, PA (US)

(21) Appl. No.: 11/770,227

(22) Filed: Jun. 28, 2007

Related U.S. Application Data
(60) Provisional application No. 60/817,154, filed on Jun. 29, 2006.

(51) Int. Cl. G06F 15/16

(52) U.S. Cl. 709/219

(57) ABSTRACT

A method and system for automated publication to web pages, such as wikis, of content automatedly extracted from conventional e-mail or text messages, and more particularly to creation and/or maintenance of wiki-style web pages. In one embodiment, the method involves the system receiving a message comprising a textual body, and identifying a segment of the textual body for publishing to the web page. The segment includes at least a fractional portion of the textual body. The method further includes selecting, from among a plurality of web pages, at least one web page to which the segment is deemed topically relevant, and adding the segment to the web page so that the segment is displayed to any users browsing the web page. Optionally, the system transmits to at least one user an e-mail message alerting the user to added content, and permits the user to edit the web page.

### CROSS-REFERENCE TO RELATED APPLICATION

This application claims the benefit of U.S. Provisional Patent Application No. 60/817,154, filed Jun. 29, 2006, the entire disclosure of which is hereby incorporated herein by reference.

### FIELD OF THE INVENTION

The present invention relates generally to a method and apparatus for automated publication to web pages of textual content automatedly extracted from conventional e-mail messages, text messages, etc. and more particularly to creation and/or maintenance of wiki-style web pages.

### DISCUSSION OF THE RELATED ART

In both personal and commercial contexts, a considerable amount of interpersonal communication is conducted by exchange of e-mail messages. By nature, e-mail messages are essentially private communications between the sender and recipient(s). Typically, they are viewed only by the sender and the intended recipient(s), e.g. via a mail client software program executing on a personal computer, PDA, smartphone, or other microprocessor-containing computerized device. Typically, at least in the electronic communications medium context, each individual receives via the individual's e-mail client software and can view only messages directed to that individual's respective e-mail address. While some systems may permit viewing of e-mail messages by others, those systems do typically not permit editing of those e-mail messages.

Each e-mail message is discrete, and typically includes information identifying a sender's name and/or e-mail address, a recipient's name and/or e-mail address, and a timestamp showing when the associated message was received by the recipient's e-mail system. It is not uncommon for an original e-mail message, a reply e-mail message, and subsequent messages from one or more parties to become concatenated in a “chain” to form an e-mail “thread,” which is essentially a compilation, in reverse chronological order, of related individual e-mail messages, each of which includes static text.

Accordingly, e-mail messaging is not particularly well-suited to widespread collaboration among a broad group of individuals including individuals that may not be identifiable at the time of sending of an e-mail message, or for whom an e-mail address may not be presently available, accessible, etc. Therefore, e-mail messaging, and similarly text (SMS) and voice mail messaging, does not provide a generally accessible, editable repository of knowledge, information, etc.

In an effort to allow for broader knowledge and information sharing among individuals, some corporations, organizations and other enterprises provide software-based searching capability within their proprietary communications networks. Suitable e-mail searching software is commercially or publicly available from a variety of sources. For example, Google's gmail procude allows users to search for terms in their own e-mail messages. Commercially available list-management software stores and allows users to access e-mail messages sent to a list of users. Examples of such software include ListProc software developed by the Corporation for Research and Educational Networking (CREN), Majordomo proprietary mailing list manager developed by Great Circle Associates of San Francisco, Calif., and Lyris list manager software developed by Lyris Technologies, Inc. of Emeryville, Calif. For example, this capability allows an employee having an e-mail account within his employer's network to search for, retrieve and view e-mail messages of other employees having e-mail accounts within the same network. While this allows for a certain measure of information sharing, it is still provided in the context of review of static e-mail messages. Further, the information is not organized, summarized, or compiled; it is available only in its raw form, i.e., in the form of the original e-mail messages.

Some information sharing and collaboration is presently conducted through the use of wiki-style web pages, or “wikis”. As generally known in the art, a “wiki” is a widely accessible website, including one or more web pages, that allows viewers of the website to add, remove, and edit the content displayed thereon. Such wikis typically allow for hypertext or other linking to other web pages. Accordingly, unlike static e-mail message content, wiki content is dynamic in that it is an editable, updatable repository for a body of information, not merely a historical compilation of static e-mail messages. For example, a wiki might be established to allow programmers to share information relating to software development, to allow salespersons to share information about sales contacts, relationships, and the status of proposed sales, to allow information technology (IT) help desk staffers to share information about known problems and recommended solutions, etc. Accordingly, a wiki can be an effective tool for collaborative work among members of a team, particularly teams having geographically diverse members.

However, the quality of any particular wiki is limited by the amount and quality of the efforts of its contributors, authors, editors, etc. (collectively, “contributors”). Particularly in the business context, the designated contributors may not be those individuals with adequate substantive knowledge, and thus the quality of the wiki may suffer. For example, software engineers may be assigned the task of contributing to a wiki by manually publishing and editing information relating to sales contacts and relationships, which they may know little about. Alternatively, those individuals with the substantive knowledge may be made responsible for acting as contributors, but they may lack the skills or inclination to take the affirmative steps and perform the additional work required to manually contribute to the wiki, and thus the quality of the wiki may suffer.

### SUMMARY OF THE INVENTION

The present invention provides a method and apparatus for automated publication to web pages of textual content automatedly extracted from conventional e-mail or text (SMS) messages, or even from voice-mail messages from which text has been created by automated speech recognition software, and more particularly to creation and/or maintenance of wiki-style web pages. Thus, conceptually speaking, the present invention allows textual information for inclusion in a wiki to be obtained from those who have relevant personal, substantive knowledge, and further facilitates automatedly publishing of the textual information, thus eliminating most or all of the additional labor typically associated with publishing information to a wiki, etc. Further, it allows for extraction of such information from e-mail, text (SMS) or voice mail messages (collectively, “messages”) that are prepared during the normal course of business or other operations.

In one embodiment, a method for publishing information to a web page comprises a computerized system receiving, via a communications network, a textual message comprising a textual body; identifying a segment of said textual body for publishing to the web page, said segment comprising at least a fractional portion of said textual body; selecting, from among a plurality of web pages, at least one web page to which said segment is deemed topically relevant; and adding said segment to the web page so that the segment is displayed to any users browsing the web page.

### BRIEF DESCRIPTION OF THE DRAWINGS

The present invention will now be described by way of example with reference to the following drawings in which:

FIG. 1 is a diagrammatic view of an exemplary communications network including a system in accordance with an exemplary embodiment of the present invention;

FIG. 2 is a flow diagram showing an overview of an exemplary embodiment of a method for publishing information to a web page in accordance with an exemplary embodiment of the present invention;

FIG. 3 is a flow diagram showing an exemplary alternative embodiment of a method for publishing information to a web page in accordance with an exemplary embodiment of the present invention; and

FIG. 4 is a block diagram showing diagrammatically an exemplary system in accordance with the present invention.

### DETAILED DESCRIPTION

An embodiment of the present invention provides a method and apparatus for automatedly publishing (i.e. submitting and/or posting) textual information to web pages, such as wikis. The information includes content automatedly extracted from conventional e-mail, text (SMS) or voice mail messages. In embodiments in which the original message is a voice mail message received via a telephone, a textual representation of the voice mail message, i.e., a textual message, is created by an automated process by which speech recognition software analyzes the voice mail message and creates a corresponding textual message. Commercially available speech recognition software may be used for this purpose.

Thus, conceptually speaking, the present invention allows information for inclusion in a wiki to be obtained from those who have relevant personal, substantive knowledge, and further facilitates automated publishing of information to a web page, wiki, etc., thus eliminating most of all of the additional labor typically associated with contributing information to a wiki, etc.

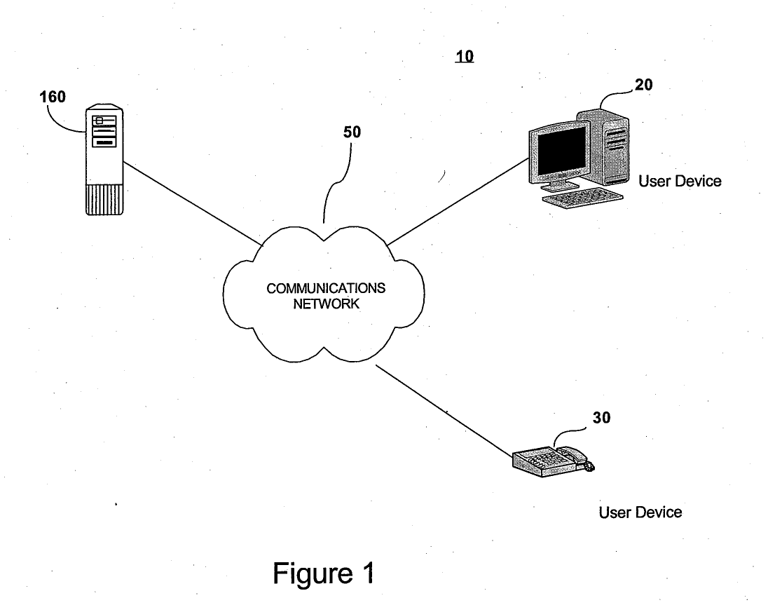

Referring now to FIG. 1, a block diagram shows diagrammatically a simplified network 10 in accordance with the present invention. Actual network topology should be expected to be significantly more complex. As shown in FIG. 1, the exemplary system includes conventional computing hardware of a type typically found in client/server computing environments. More specifically, the network 10 includes a conventional user/client devices 20, such as conventional desktop PCs, enabling a user to communicate via a communications network 50 such as the Internet. The exemplary user device 20 is configured with conventional web browser software, such as Microsoft Corporation's Internet Explorer web browser software, for interacting with websites via the network 50. Additionally, each exemplary user device 20 is configured with conventional software for sending and receiving textual messages. In the example of a PC, such software may be Microsoft Corporation's Outlook or Outlook Express software for sending and receiving e-mail messages. Alternatively, in the context of mobile/wireless telephone or PDA devices capable of sending and receiving SMS text messages, such as a Blackberry device manufactured and/or distributed by Research In Motion Limited of Waterloo, Ontario, Canada, or a Treo device manufactured and/or distributed by Palm, Inc. of Sunnyvale, Calif., proprietary and/or other conventional software may be used.

In one embodiment, the user device 30 may be a telephone for sending a voice mail message via the communications (telephone, Internet, etc.) network 50. In such an embodiment, the system may include or interface with conventional voice mail hardware and software such that the system 160 receives the voice mail message for analysis, e.g. by speech recognition software, such as IBM's ViaVoice, Nuance's Dragon Dictate or similar computer software capable of analyzing speech and creating a textual transcription of such speech.

The exemplary network 10 further includes a system 160 including conventional server hardware and software. The system may store certain conventional executable software, but is specially configured in a novel manner consistent with the present invention, as discussed in greater detail herein. By way of example, the system may store software for receiving, processing and/or transmitting e-mail messages, and for editing those messages. Generally available LISTSERV (listserver) software may be suitable for this purpose. For example, the widely available, open source Mailman LISTSERV software manufactured and/or distributed by The Free Software Foundation of Boston, Mass. may be used for such purpose. As known in the art, the Mailman and certain other LISTSERV software is configured to store e-mail messages in a manner rendering them accessible via static URLs. Further, this exemplary system is configured to also provide web server and/or wiki maintenance functionality. Accordingly, the system 160 further stores the publicly available Mediawiki wiki software distributed by Wikimedia Foundation, Inc. of St. Petersburg, Fla. As known in the art, Mediawiki runs mySQL as a backend database for managing wiki data; Perl may be used for Mediawiki operations; software for carrying out the invention may be written in Python code. It will be appreciated that in other embodiments, this functionality may be provided by more than one unit of server hardware, and by other software. Any suitable hardware and software may be used.

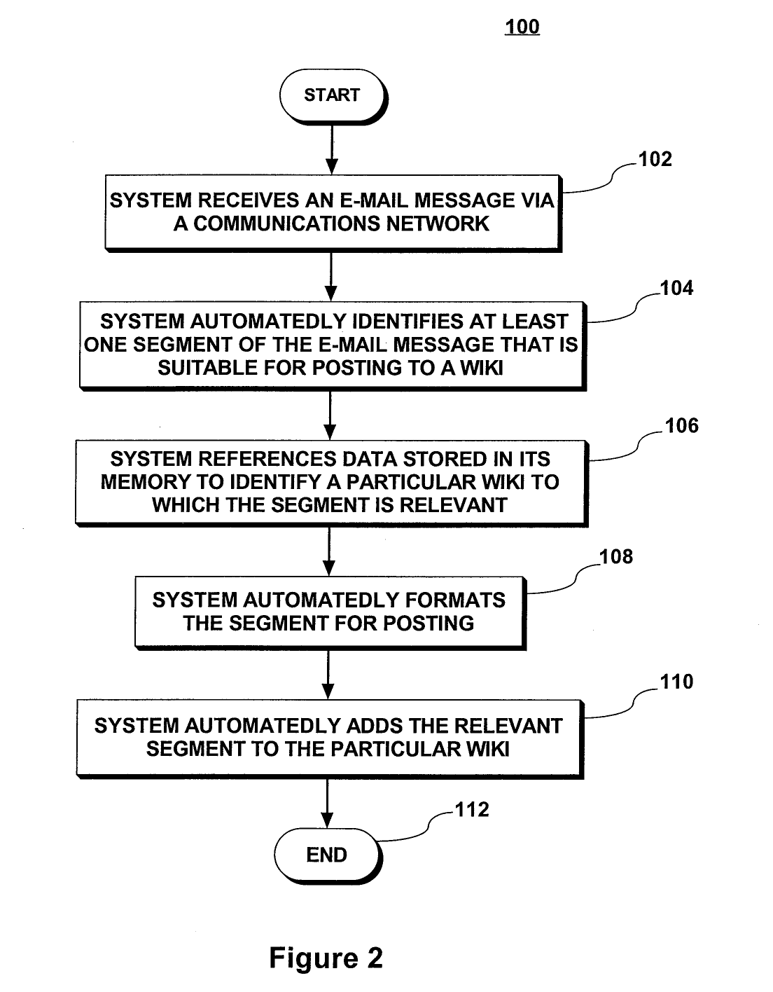

Referring now to FIG. 2, a flow diagram 100 is shown that illustrates an exemplary embodiment of a method for automatedly publishing information to a web page in accordance with an exemplary embodiment of the present invention. As shown at step 102, the method begins with the system 160's receipt of a textual message via the communications network 50. Although in other embodiments the textual message may be an SMS text message, or a textual version of a voice mail message created by voice recognition software executing on the system 160 or elsewhere, in this example, the textual messages is discussed for illustrative purposes only in the context of an e-mail message. By way of example, the system may be configured such that e-mail messages addressed from a sender to a recipient are copied and/or automatically received additionally by the system 60. Alternatively, the system may be provided with a specific e-mail address for receiving e-mails for processing in accordance with the present invention, and may receive e-mails addressed by the sender to the system as a recipient. The e-mail message is received via the communications network 50 by the LISTSERV, Mailman or other conventional mail management software running on the system 60. This occurs in a conventional manner, and results in storage of the e-mail message at a network location accessible via a static URL, as known in the art.

Optionally, the e-mail message (or a group of them) may be examined and effectively triaged to determine whether certain of the messages do not contain any information suitable for publishing to a web page, and if so, discarding, skipping or otherwise foregoing further processing of such messages. This may involve determining whether the e-mail message is pertinent to any wiki-type web page or portion thereof, and sending messages that don't immediately appear pertinent to a “sandbox” for possible further evaluation.

Next, in accordance with the present invention, the system 160 automatedly identifies at least one segment of the e-mail message that is suitable for publishing to a web page, such as a wiki-type web page, as shown at step 104. The segment may include, for example, the entire e-mail message, the entire body portion of the e-mail message, or a fractional (i.e., a part less than the whole) portion of the body portion of the e-mail message, such as a paragraph, sentence, or phrase. This identification may be conducted in any suitable manner, according to the preferences of the system's operator, administrator, etc. In a preferred embodiment, salutations and signatures are recognized and removed from the e-mail message, as are “boilerplate” sections such as “click here for a free hotmail account” or “this message prepared using Dragon Naturally Speaking”, and the remaining text is segmented either into paragraphs or into questions and responses.

The system then references data stored in its memory to identify a particular web page, such as a wiki-type web page, to which the segment is considered likely to be relevant, as shown at step 106. Generally, for each segment of text, there are three possible outcomes: (1) it may be determined that the segment is not worth storing to the wiki; (2) it may be determined that the segment is worth storing, but there is currently no suitable page on which to store it; or (3) it may be determined that the text should be added to one or more existing wiki pages. The system 160 stores in its memory information to be used for making this identification. This identification may be conducted in any suitable manner, according to the preferences of the system's operator, administrator, etc. For example, entity recognition, typing and resolution techniques may be used; various techniques and hardware and software for carrying out such techniques are well-known in the art.

Alternatively, text categorization technologies may be used to identify a segment suitable for publishing, e.g. a segment of text that relates to a topic. For example, various statistical methods may be used for this purpose. Alternatively, the system may simply be configured to extract a segment that excludes header information and prior e-mail content contained in the original message.

For example, in an embodiment in which entity recognition, typing and resolution techniques are used, the system may store entity information to which each web page pertains, and a comparison may be made between a segment's entity/entities and the web page's entity/entities to determine whether there are any matches. Alternatively, generally known information retrieval analytical techniques, such as a variant of the TF/IDF cosine technique, may be used to compute similarity between text of the e-mail message and text of a web page, so that a particular website or websites having a sufficiently high degree of similarity with the e-mail message may be identified.

The system 160 then automatedly formats the segment for publishing on the web page, as shown at step 108. For example, if the e-mail included only simple (ASCII) text, and the web page contains HTML formatting, HTML tags may be added to the segment of text extracted from the e-mail message to render the segment compatible for publishing purposes. Alternatively, for example, if the e-mail message included HTML formatted text, additional tags may be added to the segment of text extracted from the e-mail message to render the segment compatible with wiki-style formatting for publishing purposes.

Finally, in this exemplary embodiment, the system automatedly adds the relevant segment to the particular web page/wiki to which the segment was determined to have relevance, as shown at step 110. By way of example, in the context of wikis, this may be performed programmatically using a function call of the MEDIAWIKI software.

Accordingly, as illustrated in FIG. 2, the system receives an e-mail message, identifies a portion of the message deemed to be relevant for posting to a web-page/wiki, performs formatting, if necessary, to render the portion suitable for publication, and then publishes a portion of the e-mail message to the web page/wiki.

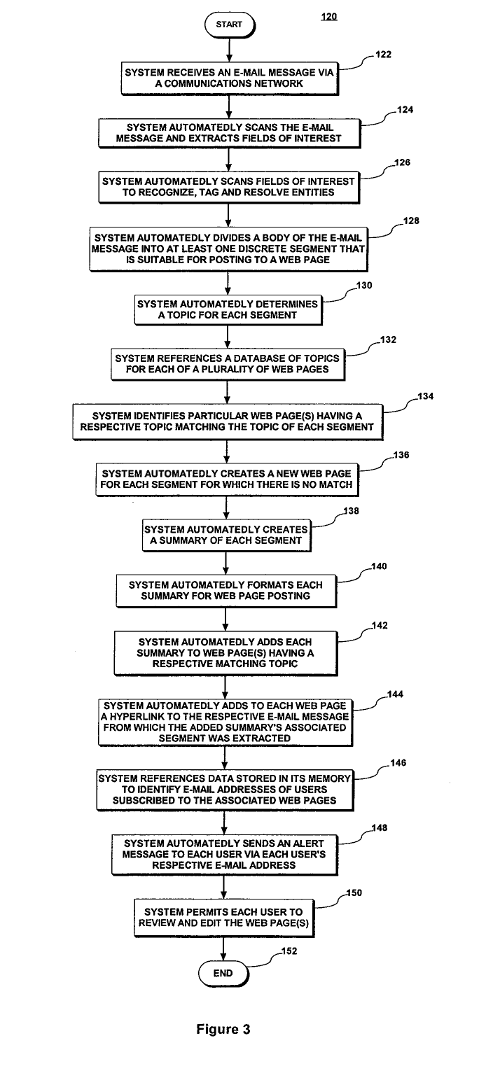

An alternative embodiment is discussed in detail with reference to FIG. 3, which shows a flow diagram 120 showing an exemplary alternative embodiment of a method for publishing information to a web page. Referring now to FIG. 3, the method begins with the system's receipt of an e-mail message, as shown at step 122. This occurs in a manner similar to that discussed above with reference to step 102 of FIG. 2.

The system 160 then automatedly scans the e-mail message and extracts fields of interest, as shown at step 124. For example, the system 160 may be configured to parse the e-mail message to identify sender, recipient, date, title and body fields, and related text. Accordingly, in this step, terms and phrases of interest, i.e. those contained within the fields of interest, are identified within the incoming e-mail message. Consistent with the present invention, the fields of interest to be extracted may be predetermined as desired, and the system may be configured accordingly.

This exemplary embodiment uses conventional entity recognition and resolution techniques. As is generally known in the field of entity recognition, typing and resolution, in this context, an entity may be a thing, a person, a concept or any other suitable topic for a web/wiki page. Entity recognition involves determining that some sequence of letters/words (a “mention”) refers to an entity. It is often useful to determine of what type the entity is, e.g. a person, a restaurant, a company or a fruit. These results are often stored in the form of marked-up text to delineate where an entity begins and ends. For example, the phrase “I went to the Black Banana” may be marked up with tags as follows: “I went to the <restaurant>Black Banana</restaurant>” to tag “Black Banana” as a restaurant-type entity. They may also be stored as offsets indicating the location in the text. Entity (or reference) resolution involves determining to which particular entity a term refers. This process is also referred to as disambiguation. For example, there may be unrelated persons having the same name, e.g., “Michael Douglas”, or a single person may be identified in different ways, e.g. “Michael Douglas” or “M. Douglas.” Often a part or the entirety of a wiki page will be about a given entity (e.g. a particular actor or restaurant). Resolution then involves determining the particular wiki page (or portion of page) to which the mention refers.

If an entity cannot be resolved, a new web page may be created for it, as discussed in further detail below. Entity typing provides context for reference resolution. Entity typing may or may not be used to facilitate disambiguation. For example, it may be easier to resolve “Paris” if it can be typed as either a person, a place, etc. It also aids in determining what links should be added to a newly created page, or where a partial page should be placed. For example, knowing that an entity is a restaurant suggests adding it to the “restaurant” portion of the wiki.

Accordingly, in the next step, the system automatedly scans the text of the fields of interest to recognize, tag and resolve entities, as shown at step 126. As referred to above, various techniques exist for this purpose, and any suitable techniques may be used. For example, the system 160 may store a list of entity names (e.g. restaurant names), and the fields may be examined to determine whether any entity (restaurant name) from the list is present. This may involve checking for spelling variations, misspellings, abbreviations, etc. and resolving those references. If so, the term may be tagged as an entity, and resolved as to a particular name of a particular restaurant. If it is unclear, as to the context of the entity, typing may indicate that the entity is a restaurant for reference resolution purposes. By way of further example, a pattern matching technique may be used. For example, the system 160 may store a list of patterns or “regular expressions” for use in identifying entities. For example, a regular expression in the format of (DDD) DDD-DDDD, where D is a numerical digit, may represent a telephone number. A term in the e-mail matching this pattern may be tagged as an entity, with a type of telephone number, and the entity may be resolved to a specific telephone number, e.g., (123) 456-7890. By way of further example, various statistical methods may be used to recognize and resolve entities with the text of the fields of interest. As a result of this step, entities are identified and tagged. For example, HTML-like tags may be inserted among the text from the fields of interest, or a list may be created and stored that associates referenced text from the fields of interest with certain tags. This allows the e-mail message to be further analyzed, classified, and published in a reliable manner.

The system 160 then examines the e-mail message to determine which parts, if any, are suitable for publishing to a web page/wiki. For this purpose, the system 160 automatedly divides the textual body of the e-mail message into at least one discrete segment that is suitable for publishing to a web page, as shown at step 128. This automated segmentation may be performed in a variety of ways, and any suitable technique may be used. For example, this segmentation may involve extracting a segment from the e-mail that excludes text determined to be a salutation, a signature block, a confidentiality or other notice, information repeated from a prior e-mail message, etc. Further, the segment may include a fractional portion of the body. For example, the segment may include only a question from an earlier e-mail message and an associated answer from a responsive e-mail message. Various techniques are known in the art for identifying portions to be excluded, and for identifying question and answer pairs within a textual body. Further, a multi-topic e-mail may be broken down into segments so that each segment corresponds to only one topic. Conceptually, this step breaks down the e-mail into topic-specific segments for publication purposes.

In this embodiment, the system 160 then automatedly determines a topic for each segment, as shown at step 130. A topic for a segment of text may be determined in various conventional manners, and any suitable manner may be used. For example, various statistical methods, and statistical modeling software, are available to automatedly identify a topic for a body of text. By way of further example, in the context of entity recognition and resolution, a single entity found in the Subject line of an e-mail message may be considered the topic of a segment extracted from that e-mail message. If there is more than one entity in the Subject line, a natural language procedure may be used to determine which entity is considered most relevant. By way of further example, topics of other e-mail messages in the same e-mail thread as the e-mail message may be considered the segment's topic. Alternative methods exist, and any suitable method may be used for this purpose.

After the topic of each segment has been determined, the system 160 then references a database of topics for each of a plurality of web pages/wikis, as shown at step 132. For example, the topic of each web page/wiki stored in a database may be expressly stored as data associated with each web page/wiki. Alternatively, web pages stored in a database may simply be examined to determine terms in a title, entities in a title, etc.

The system 160 then identifies particular web pages/wikis having a respective topic matching the topic of the segment, for each segment, as shown at step 134. For example, simple character string matching may be used for this purpose. Accordingly, segments recognized as pertaining to a certain topic are matched with web pages/wikis pertaining to the same topic.

If, for a given segment, there is no matching web page/wiki, the system next creates a new web page/wiki having the associated topic, as shown at step 136. For example, the newly created web page/wiki may be given a title that is the topic, entity, etc.

In this embodiment, the system 160 then automatedly creates a summary of each segment, as shown at step 138. Various software tools exist to perform automated summarization of text. Generally speaking, such tools extract sentences or phrases believed to be highly contextually relevant, and then concatenate them to form a summary. In accordance with the present invention, additional logic may be applied to render such conventional tools more effective for e-mail, text or transcribed voice mail messages. For example, predictable salutations and signatures may be stripped, links may be added to entities that are described on other web pages, questions and answers can be reformatted into wiki-style format, annotations may be added, and links to the author or sender of the message may be added, consistent with wiki-style web page content. Any suitable summarization process may be used.

It should be appreciated that the summary provides a condensed version of the segment that is believed most relevant. However, in alternative embodiments, there may be no summarization, and instead the entire segment may be retained for publishing to the web page/wiki.

In this embodiment, the system 160 then automatedly formats each summary (or segment in embodiments in which a summary is not prepared) for publishing, as shown at step 140, and as discussed in greater detail above. Formatting for publication is discussed in detail above with reference to step 108 of FIG. 2. Any suitable method may be used for this purpose.

The system 160 then automatedly adds the summary of each segment to the appropriate location(s) on the web page(s), such as wiki pages, to which they relate, as shown at step 142, and as determined above as discussed with reference to step 134. Automatedly publication to a web page/wiki is discussed above with reference to step 110 of FIG. 2. Any suitable method may be used for this purpose.

In this exemplary embodiment, the system 160 further automatedly adds to each web page/wiki a hyperlink to the respective URL at which the e-mail message, from which the segment/summary was derived, may be accessed. This allows for use of a web browser to navigate back to the original e-mail message when browsing a web page/wiki including a summarized segment extracted from the original e-mail message, etc.

In this manner, information is published to a wiki or other web page in an automated manner, as a result of automated examination and processing of existing e-mail messages sent for person-to-person communication, etc. Special programming or other skills are not required to publish information to the wiki/web page.

In the exemplary embodiment, the system actively solicits manual editing of the automatedly created wiki/web page described above. This helps ensure and/or further enhances the quality of the wiki/web page. To that end, individuals may be permitted to register their e-mail addresses, e.g. by submitting them through a website interface, and opt-in to receive alerts for selected web pages/wikis when new content is added, such that those individuals may review and manually edit newly added content. Alternatively, a system administrator or other may specify an e-mail address to which an alert should be issued in response to addition of newly added content, e.g. via the publicly available MediaWiki wiki software.

Accordingly, referring again to FIG. 3, the system subsequently references data stored in its memory to identify e-mail addresses of users that are subscribed to each of the associated web pages/wikis to which new content has been added, as described above, as shown at step 146. For this purpose, the system 160 may store a database associating one or more e-mail addresses with each web page/wiki.

The system then automatedly sends an alert message to each user via each user's respective e-mail address, for each web page/wiki to which new content has been added, as shown at step 148. This alert message may be in the form of an e-mail message, and may be sent via the communications network using conventional e-mail transmission technology. The system may store a template of the alert message to be used for this purpose.

The system then displays to browsing users the web pages/wikis as web pages via the Internet, intranet, etc. using conventional technology. The system further permits users, such as the general public or registered/authenticated users, to view, review and edit the web page(s), as shown at step 150. This may be performed in a manner generally similar to methods used for existing wikis, using conventional hardware, browser software, etc.

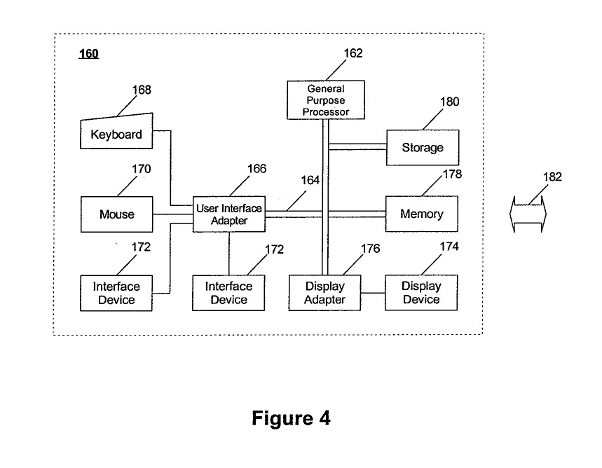

FIG. 4 is a block diagram showing diagrammatically an exemplary computerized system/server 160 in accordance with the present invention. As is well known in the art, the system of FIG. 4 includes a general purpose microprocessor (CPU) 162 and a bus 164 employed to connect and enable communication between the microprocessor 162 and the components of the server 160 in accordance with known techniques. The system 160 typically includes a user interface adapter 166, which connects the microprocessor 162 via the bus 164 to one or more interface devices, such as a keyboard 168, mouse 170, and/or other interface devices 172, which can be any user interface device, such as a touch sensitive screen, digitized entry pad, etc. The bus 164 also connects a display device 174, such as an LCD screen or monitor, to the microprocessor 162 via a display adapter 176. The bus 164 also connects the microprocessor 162 to memory 178 and long-term storage 180 (collectively, “memory”) which can include a hard drive, diskette drive, tape drive, etc.

The system 160 may communicate with other computers or networks of computers, for example via a communications channel, network card or modem 182. The system 160 may be associated with such other computers in a local area network (LAN) or a wide area network (WAN). The system 160 may be a server in a client/server arrangement. All of these configurations, as well as the appropriate communications hardware and software, are known in the art.

Software programming code for carrying out the inventive method is typically stored in memory. Accordingly, system 160 stores in its memory microprocessor executable instructions. These instructions may include micro-processor-executable instructions stored in the memory and executable by the microprocessor to carry out any combination of the steps described above.

Also provided is a computer program product recorded on a computer readable medium for configuring conventional computing hardware to carry out any combination of the steps described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method for publishing textual information to a web page using a computerized system comprising a microprocessor, a memory and microprocessor-executable instructions stored in the memory, the method comprising the system:
receiving, via a communications network, a textual message comprising a textual body;
identifying a segment of said textual body for publishing, the segment comprising at least a fractional portion of the textual body;
selecting, from among a plurality of web pages, at least one web page to which the segment is deemed topically relevant; and
adding the segment to the at least one web page so that the segment is displayed to any users browsing the at least one web page.

2. The method of claim 1, wherein the at least one web page is a wiki-type web page.

3. The method of claim 1, further comprising the system:
providing a network-accessible user interface permitting a user to edit the segment.

4. The method of claim 1, further comprising the system:
editing the at least one web page to include a hyperlink to a URL pointing to the textual message.

5. The method of claim 1, further comprising the system:
transmitting to at least one user, via the communications network, an e-mail message alerting the at least one user that the segment has been added to the at least one web page.

6. The method of claim 1, wherein said identifying a segment comprises excerpting said segment from the textual message to exclude any salutation text, signature block text, confidentiality notice text, and prior message text.

7. The method of claim 1, wherein said identifying a segment comprises excerpting the segment from the textual message to include only text of a question and answer pair.

8. The method of claim 1, wherein said identifying a segment comprises excerpting the segment from the textual message to include only text relating to a single topic.

9. The method of claim 1, wherein said selecting at least one web page to which the segment is deemed topically relevant comprises computing similarity between text of the textual message and text of each web page using an information retrieval technique and selecting each web page for which computed similarity exceeds a predetermined threshold.

10. The method of claim 9, wherein the information retrieval technique comprises a variant of the TF/IDF cosine technique.

11. The method of claim 1, wherein said selecting at least one web page to which the segment is deemed topically relevant comprises determining a topic of the segment, comparing the topic to a corresponding topic of each web page, the corresponding topics being predetermined and stored in the memory, and selecting each web page for which the topic of the segment matches the corresponding topic of the respective web page.

12. The method of claim 11, wherein the topic of the segment and the corresponding topic of each web page is determined by entity recognition and reference resolution techniques.

13. The method of claim 1, wherein adding the segment to the at least one web page comprises formatting the segment for publishing on the at least one web page.

14. The method of claim 13, wherein formatting the segment for publishing on the at least one web page comprises adding to the textual message segment tags of a type used in a wiki-style web page.

15. The method of claim 1, wherein adding the segment to the web page comprises automatedly preparing a summary of the segment, and adding the summary to the at least one web page.

16. The method of claim 1, wherein the textual message comprises an e-mail message.

17. The method of claim 1, wherein the textual message comprises an SMS text message.

18. The method of claim 1, wherein the textual message comprises text created by speech recognition software and representing a voice mail message.

19. A method for publishing textual information to a web page using a computerized system comprising a microprocessor, a memory and microprocessor-executable instructions stored in the memory, the method comprising the system:
receiving, via a communications network, a textual message comprising a plurality of fields, one of the plurality of fields comprising a textual body;
scanning the textual message to recognize fields of interest from among the plurality of fields;
scanning the fields of interest to recognize, tag and resolve entities contained therein;
excerpting from the textual body at least one discrete segment of text, each segment corresponding to a topic;
determining the topic for each segment;
referencing a database of topics for each of a plurality of web pages;
for each segment of text, selecting from among the plurality of web pages a subset of web pages comprising at least one web page having a respective topic corresponding to the respective segment's topic;
for each segment of text, creating a textual summary;
for each segment of text, adding the respective textual summary to each web page of the selected subset of web pages so that the summary will be displayed to any users browsing each web page.

20. The method of claim 19, further comprising the system:
transmitting to at least one user, via the communications network, an e-mail message alerting said at least one user that at least of the selected subset of web pages has been modified.

21. The method of claim 19, wherein excerpting from the textual body at least one discrete segment of text, each segment corresponding to a topic comprises identification of a question and answer pair in an e-mail thread.

22. The method of claim 19, wherein scanning the fields of interest to recognize, tag and resolve entities contained therein comprises use of at least one of list comparison, pattern matching and statistical analysis techniques.

23. The method of claim 22, wherein determining the topic for each segment comprises scanning the segment to recognize, tag and resolve entities contained therein;

24. The method of claim 19, wherein the at least one web page is a wiki-type web page.

25. A method for publishing textual information to a web page, the method comprising the system:
receiving, via a communications network, at a computerized system comprising a microprocessor, a memory and microprocessor-executable instructions stored in the memory, a textual message comprising a textual body;
identifying a segment of said textual body for publishing to a wiki-type web page, said segment comprising at least a fractional portion of said textual body;
selecting, from among a plurality of wiki-type web pages, at least one wiki-type web page to which the segment is expected to be topically relevant;
adding the segment to the at least one wiki-type web page so that the segment will be displayed to any users browsing the at least one wiki-type web page;
transmitting to at least one user, via the communications network, an e-mail message alerting the at least one user that the segment has been added to the at least one wiki-type web page; and
providing a network-accessible user interface permitting the at least one user to edit the at least one wiki-type web page.

26. The method of claim 1, further comprising the system:
editing the at least one web page to include a hyperlink to a URL pointing to the textual message.

27. A system for publishing information to a web page, the system comprising:
a microprocessor;
a memory; and
microprocessor-executable instructions stored in the memory and executable to carry out the method of claim 1.

28. A system for publishing information to a web page, the system comprising:
a microprocessor;
a memory; and
microprocessor-executable instructions stored in the memory and executable to carry out the method of claim 19.

29. A system for publishing information to a web page, the system comprising:
a microprocessor;
a memory; and
microprocessor-executable instructions stored in the memory and executable to carry out the method of claim 25.
